(19) United States
(12) Patent Application Publication
(10) Pub. No.: US 2007/0046753 A1
(43) Pub. Date: Mar. 1, 2007

(54) Apparatus and method for discharging protecting medium

(76) Inventor: Byung-sun Min, Pyungtack-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/512,436

(22) Filed: Aug. 30, 2006

(30) Foreign Application Priority Data
Aug. 31, 2005 (KR) 2005-0080610

(51) Int. Cl. B41J 2/01

(52) U.S. Cl. 347/101

(57) ABSTRACT

Provided is an apparatus and method for discharging a protecting medium. The apparatus includes a media checking unit for checking whether a fed medium is a protecting medium which protects a printing media; and a discharge controller for discharging the fed medium if the fed medium is a protecting medium. Accordingly, since a user does not have to individually remove protecting media, the possibility of contamination of the print media can be reduced, thereby increasing print quality. In addition, printing on a protecting medium can be prevented.

### CROSS-REFERENCE TO RELATED PATENT APPLICATION

This application claims the benefit under 35 U.S.C. §119(a) of Korean Patent Application No. 10-2005-0080610, filed on Aug. 31, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an apparatus and method for discharging a protecting medium by determining, according to certain criteria, whether a fed medium is the protecting medium.

2. Description of the Related Art

As a result of the characteristics of photo paper, photo paper is more susceptible to contamination caused by fingerprints or dust when compared to general print paper. When photo paper is contaminated by tiny particles of a foreign material, print quality decreases. Thus, to prevent photo paper from being contaminated, photo paper manufacturers place a sheet of protecting paper on the top of the photo paper.

However, it is inconvenient to individually remove the protecting paper, when supplying the photo paper into a paper cassette, and the photo paper may be contaminated when the protecting paper is removed.

Accordingly, there is a need for an improved apparatus and method for handling photo paper that is protected with a protecting medium.

### SUMMARY OF THE INVENTION

Exemplary embodiments of the present invention address at least the above problems and/or disadvantages and provide at least the advantages described below. Accordingly, an aspect of the present invention is to provide an apparatus and method for discharging a protecting medium according to a certain criterion by determining whether a fed medium is a protecting medium.

According to an aspect of the present invention, there is provided an apparatus for discharging a protecting medium, the apparatus comprising a media checking unit for checking whether a fed medium is a protecting medium which protects printing media; and a discharge controller for discharging the fed medium if the fed medium is a protecting medium.

The protecting medium may be discriminated from the printing media via a reflection of a light scanned thereon.

The media checking unit may comprise a medium sensor for receiving light reflected by scanning light on the fed medium; and a light intensity analyzer for determining whether the fed medium is a protecting medium based on an intensity of the light received by the medium sensor.

The light intensity analyzer may determine whether the fed medium is a protecting medium based on whether the intensity of the light received by the medium sensor is within a certain range.

The protecting medium may have an identification mark.

The media checking unit may comprise an identification mark sensor for sensing the identification mark and outputting the sensing result; and an identification mark checking unit for checking whether the fed medium is a protecting medium according to the result output by the identification mark sensor.

According to another aspect of the present invention, there is provided a method of discharging a protecting medium, the method comprising checking whether a fed medium is a protecting medium which protects printing media; and if the fed medium is a protecting medium, discharging the fed medium.

The protecting medium may be discriminated from the printing media via a reflection of a light scanned thereon.

The checking may comprise scanning light on the fed medium and receiving light reflected thereon; and determining whether the fed medium is a protecting medium based on an intensity of the reflected light.

In the determining, whether the fed medium is a protecting medium may be determined based on whether the intensity of the reflected light is within a certain range.

The protecting medium may have an identification mark.

The checking may comprise sensing the identification mark; and checking whether the fed medium is a protecting medium according to the result of the sensing.

According to an aspect of the present invention, there is provided a computer readable medium having recorded thereon a computer readable program for performing the method.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a conceptual diagram for explaining an apparatus for discharging a protecting medium according to an embodiment of the present invention;

FIG. 2 is a block diagram of the apparatus for discharging a protecting medium according to an embodiment of the present invention;

FIG. 3A is a block diagram of an apparatus for discharging a protecting medium according to another embodiment of the present invention;

FIG. 3B is a conceptual diagram for explaining the apparatus for discharging a protecting medium according to another embodiment of the present invention; and

FIG. 4 is a flowchart illustrating a method of discharging a protecting medium according to an embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. An apparatus and method for discharging a protecting medium, according to embodiments of the present invention, will now be described more fully with reference to the accompanying drawings.

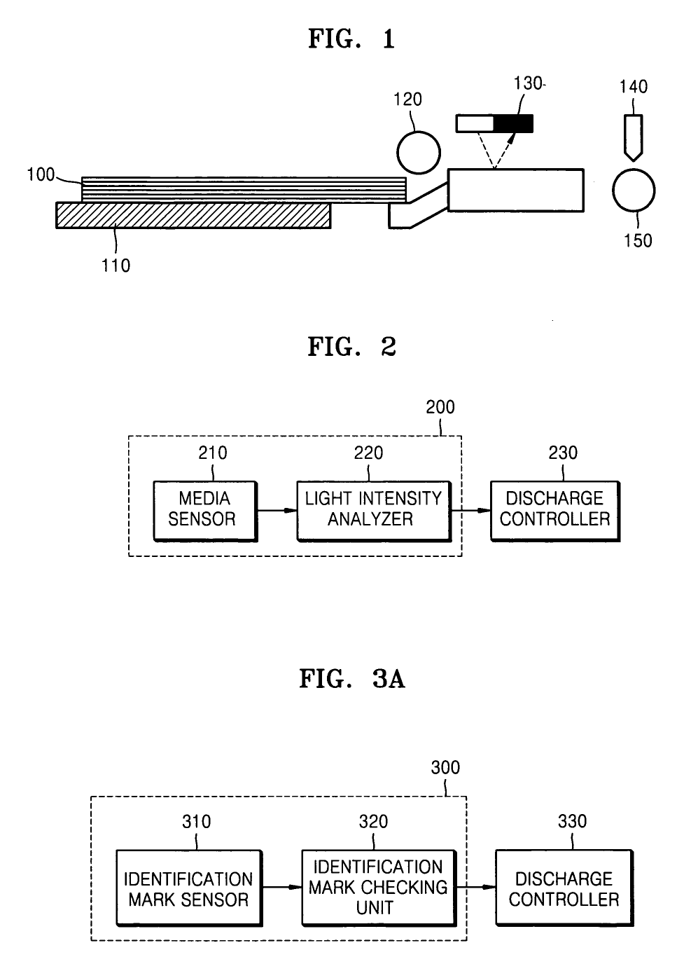

FIG. 1 is a conceptual diagram for explaining an apparatus discharging a protecting medium according to an embodiment of the present invention.

Media 100 includes both printing media and protecting media.

Printing media is media which can be printed. As a result of the characteristics of photo paper, photo paper is more susceptible to contamination caused by fingerprints or dust when compared to general printing paper. Protecting media is used to prevent foreign material from attaching to the printing media when a user supplies or handles the printing media.

Since the printing media is white, the printing media substantially reflects all of the light scanned thereon. However, since the protecting media is either red, green, or yellow, an intensity of reflection of light scanned thereon is different from that of the printing media.

A media cassette 110 stores the printing media and the protecting media.

When a print request is input by a user, media feeding roller 120 feeds medium 100 in order to perform a print task.

An optical sensor 130 scans light onto the medium 100 and receives light reflected from the medium 100.

A thermal print head 140 generates heat and transfers dyes onto the medium 100.

A transfer roller 150 discharges the medium 100 so as to correspond to a position where the thermal print head 140 transfers the dyes onto the medium 100, and presses the medium 100.

FIG. 2 is a block diagram of the apparatus for discharging a protecting medium according to an embodiment of the present invention. Referring to FIG. 2, the apparatus for discharging a protecting medium includes a media checking unit 200 and a discharge controller 230.

The media checking unit 200 checks whether a medium 100 fed by the media feeding roller 120 is a protecting medium and outputs the checking result.

The media checking unit 200 includes a media sensor 210 and a light intensity analyzer 220.

The media sensor 210 receives light reflected from the medium 100 by scanning light onto the medium 100 fed by the media feeding roller 120 using a sensor, such as the photo sensor 130.

The light intensity analyzer 220 determines whether the medium 100 fed by the media feeding roller 120 is a protecting medium based on the intensity of the light received by the media sensor 210. Here, the light intensity analyzer 220 determines whether the medium 100 fed by the media feeding roller 120 is a protecting medium based on whether the intensity of the light received by the media sensor 210 is within a certain range.

In an embodiment of the present invention, the light intensity analyzer 220 includes an analog-to-digital converter (ADC) (not shown), and thereby outputs a low level signal when the intensity of the light reflected from the medium 100 is received by the media sensor 210 and outputs a high level signal when the intensity of the light reflected from the medium 100 is not received by the media sensor 210. Since protecting media are either red, green, or yellow, while the printing media are white and therefore substantially reflect all scanned light, the intensity of light reflected from the protecting medium is within a specific range between the low level signal and the high level signal. The low level signal and the high level signal can be changed according to a circuit configuration of the media sensor 210.

The discharge controller 230 discharges the medium 100 fed by the media feeding roller 120 without being printed if the light intensity analyzer 220 determines that the medium 100 is a protecting medium by analyzing the intensity of the received light. After the discharge controller 230 discharges the medium 100 fed by the media feeding roller 120, the discharge controller 230 outputs a control signal commanding the media feeding roller 120 to feed another medium 100 in order to print requested data.

However, if the light intensity analyzer 220 determines that the medium 100 is a printing medium in response to the intensity of the received light, the discharge controller 230 prints using the newly fed medium 100.

If a high level signal is output from the light intensity analyzer 220, the discharge controller 230 perform a print task with respect to the medium 100 fed by the media feeding roller 120 in response to the output signal. If a signal corresponding to a specific range between the low level signal and the high level signal is output from the light intensity analyzer 220, the discharge controller 230 discharges the medium 100 fed by the media feeding roller 120 without being printed.

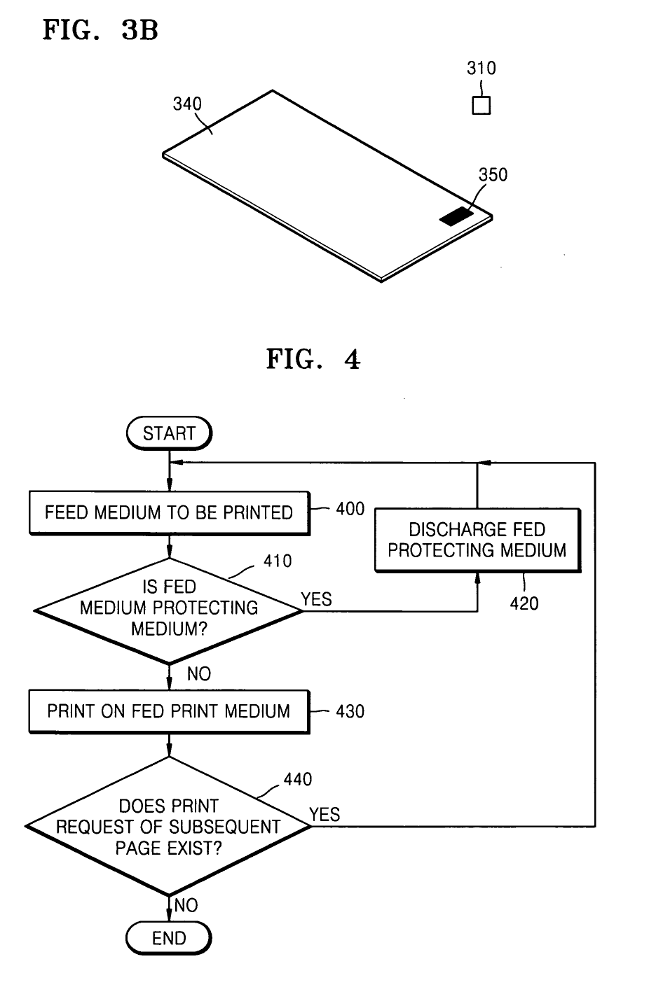

FIG. 3A is a block diagram of an apparatus for discharging a protecting medium according to another embodiment of the present invention. The apparatus for discharging a protecting medium of FIG. 3A includes a media checking unit 300 and a discharge controller 330. An operation of the apparatus for discharging a protecting medium will now be described with reference to FIG. 3B.

Protecting media 340 has an identification mark 350, such as a bar code or colored and/or shaded area of a certain size and/or shape.

The media checking unit 300 checks whether a medium 100 fed by the media feeding roller 120 is a protecting medium 340 and outputs the checking result.

The media checking unit 300 includes an identification mark sensor 310 and an identification mark checking unit 320.

The identification mark sensor 310 senses the identification mark 350 included in a protecting medium 340 using a sensor and outputs the sensing result to the identification mark checking unit 320.

The identification mark checking unit 320 checks whether a medium 100 fed by the media feeding roller 120 is a protecting medium 340 in response to the result output from the identification mark sensor 310 and outputs the checking result to the discharge controller 330.

The discharge controller 230 discharges the medium 100 fed by the media feeding roller 120 without being printed only if the identification mark checking unit 320 determines that the medium 100 is a protecting medium 340. After the discharge controller 230 discharges the medium 100 fed by the media feeding roller 120, the discharge controller 230 outputs a control signal commanding the media feeding roller 120 to feed another medium 100 in order to perform a print task.

FIG. 4 is a flowchart illustrating a method of discharging a protecting medium according to an embodiment of the present invention.

Referring to FIG. 4, in operation 400, a medium is fed to perform a print task.

In operation 410, it is determined whether the medium fed in operation 400 is a protecting medium.

In an embodiment of the present invention, operation 410 is performed based on the intensity of the light reflected from the medium.

In another embodiment of the present invention, operation 410 is performed by preparing protecting media with an identification mark 350, such as a bar code or colored and/or shaded area of a certain size and/or shape, and sensing whether the identification mark 350 exists on the medium using a sensor.

If it is determined in operation 410 that the fed medium is a protecting medium, in operation 420, the medium fed in operation 400 is discharged without being printed.

Then, in operation 400, a new medium is fed to perform a print task.

If it is determined in operation 410 that the newly fed medium is a printing medium, in operation 430, a print task is performed on the newly fed medium.

In operation 440, it is determined whether a print request for a subsequent page exists.

If it is determined in operation 440 that a print request for a subsequent page exists, a new medium is fed to perform a print task.

The present invention may be embodied in a general-purpose computer, including all kinds of devices having an information processing function, by running a program from a computer-readable medium. Exemplary computer-readable mediums include, but are not limited to, to storage media such as magnetic storage media (ROMs, RAMs, floppy disks, magnetic tapes, etc.), optically readable media (CD-ROMs, DVDs, etc.), and carrier waves (transmission over the internet).

As described above, by using an apparatus and method for discharging a protecting medium according to the present invention, a printing medium is discharged if it is determined according to certain criteria that the printing medium is a protecting medium.

Thus, since a user does not have to individually remove protecting media, the possibility of contamination of the printing media can be reduced, thereby increasing print quality. In addition, printing on a protecting medium could be prevented.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An apparatus for discharging a protecting medium, the apparatus comprising:
a media checking unit for checking whether a fed medium is a protecting medium which protects printing media; and
a discharge controller for discharging the fed medium if the fed medium is a protecting medium.

2. The apparatus of claim 1, wherein the protecting medium is discriminated from the printing media via a reflection of a light scanned thereon.

3. The apparatus of claim 2, wherein the media checking unit comprises:
a medium sensor for receiving light reflected by scanning light onto the fed medium and; and
a light intensity analyzer for determining whether the fed medium is a protecting medium based on an intensity of the light received by the medium sensor.

4. The apparatus of claim 3, wherein the light intensity analyzer determines whether the fed medium is a protecting medium based on whether the intensity of the light received by the medium sensor is within a certain range.

5. The apparatus of claim 1, wherein the protecting medium has an identification mark.

6. The apparatus of claim 5, wherein the identification mark comprises a bar code or colored and/or shaded area of a certain size and/or shape.

7. The apparatus of claim 5, wherein the media checking unit comprises:
an identification mark sensor for sensing the identification mark and outputting the sensing result; and
an identification mark checking unit for checking whether the fed medium is a protecting medium according to the result output by the identification mark sensor.

8. A method of discharging a protecting medium, the method comprising:
checking whether a fed medium is a protecting medium which protects printing media; and
if the fed medium is a protecting medium, discharging the fed medium.

9. The method of claim 8, wherein the protecting medium is discriminated from the printing media via a reflection of a light scanned thereon.

10. The method of claim 9, wherein the checking comprises:
scanning light onto the fed medium and receiving light reflected thereon; and
determining whether the fed medium is a protecting medium using an intensity of the reflected light.

11. The method of claim 10, wherein in the determining, whether the fed medium is a protecting medium is determined based on whether the intensity of the reflected light is within a certain range.

12. The method of claim 8, wherein the protecting medium has an identification mark.

13. The apparatus of claim 12, wherein the identification mark comprises a bar code or colored and/or shaded area of a certain size and/or shape.

14. The method of claim 12, wherein the checking comprises:
sensing the identification mark; and
checking whether the fed medium is a protecting medium according to the result of the sensing.

15. A computer readable medium having recorded thereon a computer readable program for discharging a protecting medium, comprising:
a checking code segment for checking whether a fed medium is a protecting medium which protects printing media; and
a discharging code segment for discharging the fed medium if the fed medium is a protecting medium.

16. The computer readable medium of claim 15, wherein the protecting medium is discriminated from the printing media via a reflection of a light scanned thereon.

17. The computer readable medium of claim 16, wherein the checking code segment comprises:
a scanning code segment for scanning light onto the fed medium and receiving light reflected thereon; and
a determining code segment for determining whether the fed medium is a protecting medium using an intensity of the reflected light.

18. The computer readable medium of claim 17, wherein in the determining code segment, whether the fed medium is a protecting medium is determined based on whether the intensity of the reflected light is within a certain range.

19. The computer readable medium of claim 15, wherein the protecting medium has an identification mark.

20. The apparatus of claim 19, wherein the identification mark comprises a bar code or colored and/or shaded area of a certain size and/or shape.

21. The computer readable medium of claim 19, wherein the checking code segment comprises:
a sensing code segment for sensing the identification mark; and
another checking segment for checking whether the fed medium is a protecting medium according to the result of the sensing.
